(19) United States
(12) Patent Application Publication
(10) Pub. No.: US 2018/0154908 A1
(43) Pub. Date: Jun. 7, 2018

(54) MULTI-PURPOSE VEHICLE SMART MONITORING SYSTEM AND METHOD

(71) Applicants: Yuqing Chen, Shenzhen (CN); SHENZHEN GTS TECHNOLOGY CO., LTD, Shenzhen (CN)

(72) Inventor: Yuqing CHEN, Shenzhen (CN)

(21) Appl. No.: 15/886,828

(22) Filed: Feb. 1, 2018

Related U.S. Application Data
(63) Continuation of application No. PCT/CN2015/000547, filed on Aug. 3, 2015.

(51) Int. Cl. B60W 50/14; G07C 5/00; G07C 5/08; B60W 50/00

(52) U.S. Cl. CPC B60W 50/14; G07C 5/008; B60W 2040/0818; B60W 50/0097; B60W 2050/143; G07C 5/0858

(57) ABSTRACT

A multi-purpose vehicle smart monitoring system and method. The monitoring system normally works in a standby manner for saving power in a smart sleep mode. When it is sensed that abnormalities occur inside, outside or around a vehicle, the monitoring system will start an automatic monitoring equipment, and notify a vehicle owner, so that the vehicle owner learns in a timely manner instant information about the vehicle and a peripheral condition of the vehicle anytime and anywhere. The vehicle owner also can operate the multi-purpose vehicle smart monitoring system so as to learn a real-time condition of and around the vehicle, and further can realize a plurality of functions, such as safe driving assistance and emergency assistance during driving.

### TECHNICAL FIELD

The present application relates to a multi-purpose vehicle smart monitoring system, and more particularly relates to a multi-purpose vehicle smart monitoring system which is capable of enabling a vehicle owner to learn about real-time conditions of a vehicle and audio and video information inside and outside the vehicle at any time when the vehicle is switched off to turn off a power supplement and the system is under a power-saving sleep standby mode with the use of a built-in battery of the system by transmitting the timely recorded abnormal audio and video information of the vehicle and around the vehicle to a smart phone of the vehicle owner through automatic monitoring equipment awakening once the abnormal condition is sensed by a smart sensing device, can be operated through the smart phone for human-vehicle interaction, and has the functions of safe driving assistance, emergency assistance, entertainment and the like during driving, as well as a method for the system.

### BACKGROUND ART

With the increasing number of vehicles, vehicle-related crimes are becoming more and more diversified: measures for stealing vehicle properties such as stealing of vehicle parts, breakage of vehicle windows, prying of vehicle doors and trunks and technical unlocking are upgraded continuously, and in an unattended case, accidents such as rubbing collision by other vehicles or malicious scratching are happening constantly, and the insecurity of the vehicle is increasing every day. Nowadays, smart phones have become personal carry-on necessities. To guarantee the safety of the vehicle properties, and promote the safety quality of life and the smart guard awareness of people, a smart monitoring visual system, which may effectively stop crimes, also assist a driver in safe driving, emergency assistance, entertainment and the like during vehicle running and facilitate multi-angle monitoring of the vehicle and the safe driving assistance of a user at any time anywhere, will come onto the market soon. The multi-purpose vehicle smart monitoring system would make your life fashionable, smart and safe, and let your vehicles be with you. Everything before us is under control.

In the face of rampant thieves, current vehicle safety precautions may only delay the time of a thief successfully stealing a thing at the most, but cannot achieve a complete precaution effect; moreover, as a matter of fact, due to objective factors such as parking difficulty and a shortage of parking spaces, it has become a universal phenomenon that vehicles are parked in unattended lots; people who follow regular life routines, often go on a long journey, drive vehicles instead of walking or often stay outside are most likely to become targets of the thieves. As long as a thief has enough time to commit a crime, it is a piece of cake for him to pry and unlock a vehicle door or break a vehicle window and destroy an antitheft device, so that ideal and effective precautionary measures should inform a vehicle owner or connect a 110 alarming platform immediately before the thief intends to commit theft, when a burglar alarm is sounded and when the thief is stealing to effectively stop the stealing behavior, and should fast transmit pictures and voices, which are recorded by a site monitoring visual system, to the smart phone of the owner through a mobile communication module to take these pictures and voices as effective evidences and clues for arresting the thief; and therefore, a crime may be effectively stopped. During vehicle running, by application of the multi-purpose smart safety monitoring system capable of realizing driver safe driving assistance reminding, emergency assistance and the like, a series of prompts of safe and smart convoying driving of vehicles between “static and dynamic” will be guaranteed more perfectly all around.

However, conventional safety precautionary measures are implemented via a key of a vehicle manufacturer of origin or simple alarming (which may be only heard beside the vehicle), or an added antitheft system, and a GPS (Global Positioning System) or GSM (Global System for Mobile Communications) burglar alarm still may not really monitor conditions inside and outside of the vehicle, and even may not effectively obtain audio and video information and the like inside and outside the vehicle either; if the vehicle is stolen, this burglar alarm only plays a role in positioning, and meanwhile, the thief can find a way to fail the positioning and burglar alarm functions. An automobile data recorder is a video recorder using an automotive alternator and a small-capacity battery, and may be also only used during the vehicle running just like a monitor on a bus or a taxi; after the vehicle is switched off, it is impractical to use the automotive alternator. It will run out of the electricity in a vehicle storage battery, so that the vehicle cannot start again and normal use of the vehicle is affected. The monitor on the bus or the taxi is high in power consumption, and has no built-in battery power supply; although the automobile data recorder has a built-in battery, it only achieves an instant storage effect after the vehicle stops and is switched off; even if an automobile data recorder with a higher-capacity battery is used, it cannot work for long, and it is hard to work for one hour and cannot record something valuable. Besides short working hours of an external battery, a monitoring angle and range are limited, and nothing can be monitored at night! Multi-angle real-time monitoring and low-light-level night vision monitoring may not be realized, power-saving standby work under a smart sleep mode may not be achieved, valuable audio and video information may not be sensed and found in real time, and the vehicle owner and an alarm platform cannot be informed timely and effectively. Nowadays, during running, the vehicle rarely has multi-purpose series monitoring systems related to driver safe driving assistance, emergency assistance and the like; most products have single functions, need to be installed via wires, are lack of human-vehicle interaction and linkage, and have many design defects such as high power consumption, complicated wiring and tedious installation.

### SUMMARY OF THE INVENTION

The present application aims to provide a multi-purpose vehicle smart monitoring system which does not need to be installed with wires, is capable of independently working to eliminate the tedious wiring installation and avoid the damage to a vehicle body, and may be independently operated and installed without participation of professionals. In a place where no one guards a vehicle, the multi-purpose vehicle smart monitoring system may be automatically detected and started. This system has the biggest characteristic of having a built-in independent high-capacity rechargeable battery; when the vehicle is switched off to turn off a power supplement, the system may be in a power-saving standby state only with its built-in power supply, and it works in a power-saving standby manner under a smart sleep mode at ordinary times; only when a smart sensing device in the system senses abnormalities inside, outside and around the vehicle, that is, only when the vehicle is infringed by an external force or a thief intrudes into the vehicle (for example infringements under the action of the external force, such as tapping or breakage of a vehicle window, opening of a vehicle door and prying of a trunk, or slight scratching, rubbing collision and extremely high peripheral amplitude on the vehicle), the multi-purpose vehicle smart monitoring system would start automatic monitoring equipment in it to record information such as AVs (Audio Videos) (images and voices of a crime committing process of a thief) of the instantaneous abnormalities inside, outside and around the vehicle, and transmit the information such as the real-time AVs recorded via monitoring to a smart phone and a backup smart phone or a PC mobile terminal of a vehicle owner through a mobile communication device and a WEB communication carrier in the system (to prevent the vehicle from being infringed and stolen and prevent vehicle properties from being stolen by the thief, wherein recorded behaviors of the thief are used as crime evidences, and the system may also be directly wirelessly connected to an alarm command center 110 for alarming), so that the vehicle owner can learn about the instantaneous information of his/her vehicle and relevant vehicle information, such as the AVs inside, outside and around the vehicle or a geographical position of the vehicle, in time at any time anywhere, and can operate the multi-purpose vehicle smart monitoring system through an interface or an APP of the smart phone of the vehicle owner, and directly operate the multi-purpose vehicle smart monitoring system through the backup smart phone or the PC mobile terminal (which is fully authorized and set by the vehicle owner) to learn about monitored information, such as real-time situations inside, outside and around the vehicle and the AVs or the geographical position; and a series of smart operations such as reminding, checking, watching, call making, picture taking, storage, acquisition, downloading, positioning and monitoring, or transmission of the information such as the AVs to a third party may be realized at any time. Therefore, you can master the information such as the AVs inside, outside and around the vehicle or the geographical position of the vehicle to take actions in advance to further protect your vehicle. According to a vehicle model condition of the vehicle of the vehicle owner, the vehicle owner can further set and adjust all sensing indexes and functional settings in the multi-purpose vehicle smart monitoring system through a UI (User Interface) of the APP of his/her smart phone based on a TCP (Transmission Control Protocol); an EOS embedded system completes setting of the sensitivities of different smart sensors, or all functional settings such as a working way, a monitoring mode, parameter setting, configuration changeover and permission setting; after the smart phone of the vehicle owner is paired and interconnected with a wireless communication Bluetooth or a wireless network (WiFi) of the multi-purpose vehicle smart monitoring system, corresponding operations such as recognition, starting, changeover, shutting off and power-saving switching may be automatically carried out, so that the vehicle owner has a full-automatic operation experience while also enjoying the endless fun of safety protection and driving assistance.

During vehicle running, fatigue prewarning, off-tracking prevention, collision prevention prewarning and the like may be realized; during driving, anti-fatigue driving may be realized through the automatic monitoring equipment and the EOS embedded system in the multi-purpose vehicle smart monitoring system based on technologies such as human face image analysis, eye feature movement recognition and driving behavior state monitoring, and the multi-purpose vehicle smart monitoring system synchronously monitors safe driving assistance by automatically detecting and recognizing a safe distance from a front vehicle and carrying out sideline detection to judge whether the vehicle deviates from a normal running track, and also guarantees the driving safety of a driver, for example, when detecting such factors that the driver dozes off, the vehicle driven by the driver deviates from a lane and the vehicle is too close to the front vehicle, the system will send an advance prewarning signal to the vehicle owner within 0.5 second to realize reminding so as to prevent accidents of dozing off of the driver, lane off-tracking or rear-end collision with the front vehicle due to conditions of drowsiness, fatigue, negligence, distraction and the like, thereby achieving the effects of recognition of a road condition and the distance from the front vehicle, driving safety prewarning and timely reminding for dozing off of the driver, and the like.

Wireless interconnection synchronous monitoring is as follows: in the vehicle or near to the vehicle, the multi-purpose vehicle smart monitoring system may be connected to the smart phone or the PC mobile terminal of the vehicle owner through wireless interconnection WiFi, carry out interaction between latitude and longitude change information of the geographical position and real-time images such as synchronous monitoring, watching, picture taking, playing, screenshot and positioning through an APP, and also carry out relevant interactive operations of the multi-purpose vehicle smart monitoring system such as acquisition, storage and recording.

At night or in bad weather, safe driving monitoring may be assisted through infrared night vision: during driving, the smart phone or the PC mobile terminal of the vehicle owner is connected to the APP through the wireless interconnection WiFi of the multi-purpose vehicle smart monitoring system, or is wiredly connected to a built-in image display device of the vehicle for night-vision displaying, so that the multi-purpose vehicle smart monitoring system may synchronously carry out an infrared imaging technology to assist in driving image monitoring, and realize safe driving assistance functions such as dazzle light shielding, clear seeing in a foggy day and night vision assistance in weather with bad light, such as backlighting, night, daytime, snowy days, foggy days and rainy days to allow the driver to still have a clear view in a dark area beside headlamp lighting; if someone intrudes into a driving route, the system will capture the pedestrian with infrared rays and sound an alarm in time.

Driving assistance synchronous monitoring is as follows: during driving, whole-process monitoring is carried out, and in addition, relevant information such as time, speed and position is recorded; the smart phone or the PC mobile terminal of the vehicle owner may be also connected to the APP through the wireless interconnection WiFi in the multi-purpose vehicle smart monitoring system to carry out synchronous driving monitoring, thus monitoring and recording real-time AV image pictures or realizing multi-purpose operations such as a safe driving assistance function including picture taking, playback, zooming, downloading, transmission, sharing, blackmailing behavior prevention and the like, and automatic locking and storage.

A multifunctional button may be wirelessly connected with the multi-purpose vehicle smart monitoring system; in a dangerous situation, the multifunctional button may be pressed for SOS emergency assistance, or in case of a robbery, the multifunctional button may be pressed for calling the police; when receiving a wireless instruction from the multifunctional button, the system will automatically dial an emergency assistance number preset in advance by the vehicle owner, call the alarm command center 110 and the like, and in addition, it will transmit detailed images such as current monitored scenes inside and outside the vehicle, a personnel movement trend and a facial expression and information such as the screenshots, pictures, AVs and the latitude and longitude of the geographical position to third-party platforms such as the smart phone with the emergency assistance number or the PC terminal and the alarm command center 110 in time, so that relatives and friends as well as policemen and the police department all can master and learn about real-time change information of the vehicle owner, the thief, the vehicle, the location of the vehicle, to talk or communicate with, dissuade, monitor, shout to people in the vehicle and the like through the multi-purpose vehicle smart monitoring system, and can take a further precautionary measure to sieve time to make a rescue strategy in advance; and the multifunctional button may further realize entertainments such as picture taking to find a view and short video recording and also has other multifunctional purposes.

The shortcomings that existing monitoring equipment is clumsy and inconvenient, needs to be installed through wires by a professional, has tedious assembling steps which may damage the vehicle body, may not sense the abnormalities inside, outside and round the vehicle, may not work in the power-saving standby manner under the sleep mode either, may not realize low-light-level night vision, may not realize monitoring at the dark night and also has a limited monitoring angle, and the shortcomings that audio and video information may not be transmitted to the vehicle owner and the third party in time, the vehicle owner cannot learn about the condition of his/her vehicle in time, so that the monitoring may not be effectively used, the vehicle owner cannot learn about the real-time conditions inside, outside and around the vehicle, and the audio and video transmission may not be realized are overcome. During driving, the multi-purpose vehicle smart monitoring system may overcome the shortcomings that the existing vehicle does not have relevant functions such as safe driving assistance and emergency assistance and multi-purpose monitoring, also may effectively carry out system work of reminding the driver of safe driving, emergency assistance, learning about the location of the vehicle in time and the like, and may further avoid mobile communication expenses, for example, by wireless interconnection between the WIFI in the system and the phone or the PC mobile terminal, no communication expenses will be generated by downloading, transmission, sharing and the like; the system is more convenient and fast in evidence taking, entertainment, safety, driving, interconnection, SOS and the like.

To achieve the above objective, the present application adopts the following technical solution:

A multi-purpose vehicle smart monitoring system is provided, including a smart sensing device 11, automatic monitoring equipment 12, a mobile communication device 13, a wireless interconnection device 14, a memory 15, an EOS embedded system 10, a rechargeable battery 16, a multifunctional button 3 and the like.

In the multi-purpose vehicle smart monitoring system, the smart sensing device 11 includes a high-sensitivity gyroscope sensor with an amplitude sensing function of sensing an amplitude frequency, a speed and a micro change of an angle, and an air pressure sensor capable of sensing changes of air-flow differential pressure in a vehicle. The system is characterized in that: there are multiple ways to sense abnormalities, the precision is high, and changes of abnormalities inside, outside and around the vehicle may be comprehensively or respectively and multiply sensed and identified, that is, this system works in a power-saving standby manner under a smart sleep mode at ordinary times, so that the working consumption of a battery is reduced to the maximum extent; when the vehicle is infringed by an external force or a thief intrudes into the vehicle (for example, a change of the air-flow differential pressure in the vehicle will be sensed when a vehicle window is tapped or broken, a vehicle door is opened or a trunk is pried, or changes of vibration, the amplitude frequency, the speed, a micro angle and the like will be sensed under the action of an external force such as slight scratching, knocking, rubbing collision and extremely high peripheral amplitude on the vehicle), sudden changes of the abnormalities may be comprehensively or respectively or multiply sensed; the automatic monitoring equipment 12 is started as long as the EOS embedded system 10 is awakened to carry out a series of work such as real-time monitoring, information such as abnormal AVs is transmitted to a smart phone or a PC mobile terminal 2 of a vehicle owner in time through the mobile communication device 13, and an alarm is sounded by directly using an alarm command center 4 through wireless connection, thus fulfilling smart operation aims such as human-vehicle interaction; and during vehicle running, the smart sensing device 11 also may carry out multi-purpose sensing work of assistance for a driver in safe driving, automatic locking and storage and the like.

According to the multi-purpose vehicle smart monitoring system, the automatic monitoring equipment 12 includes at least three wide-angle monitoring camera heads with night vision functions; at the dark night, clear pictures around the vehicle may be monitored through an infrared imaging technology; a group of infrared night vision smart light supplementing LEDs (Light Emitting Diodes) (infrared night vision light supplementing LEDs are started for infrared night vision light supplementation only when the sensor senses that the air-flow differential pressure generated in the vehicle such as the vehicle door or the vehicle window changes, or senses that someone intrudes into the vehicle, and the LEDs do not need to work in other states) are provided; the multi-purpose vehicle smart monitoring system is installed above a front windshield of the vehicle, and may monitor environments inside and outside the vehicle panoramically at 360 degrees in front, back, left and right directions under any light rays; the automatic monitoring equipment 12 also may automatically switch a lens to automatically detect a moving target, namely movably detecting and automatically recording a moving target appearing in a monitoring lens (a detection range: automatically detecting moving targets such as persons inside and outside the vehicle or other vehicles), and the safety of your vehicle may be protected all the time via moving detection; at night or in bad weather, the WI-FI of the wireless interconnection device 14 in the system may be also connected to the smart phone or the PC mobile terminal 2 of the vehicle owner, or is wiredly connected to a built-in image display device of the vehicle for night-vision displaying to realize infrared night vision safe driving assistance monitoring, so that the multi-purpose vehicle smart monitoring system realizes safe driving assistance functions such as dazzle light shielding, clear seeing in a foggy day and night vision assistance in weather with bad light, such as backlighting, night, daytime, snowy days, foggy days and rainy days to allow the driver to still have a clear view in a dark area beside headlamp lighting; if someone intrudes into a driving route, the system will capture the pedestrian with infrared rays and sound an alarm.

According to the multi-purpose vehicle smart monitoring system, the mobile communication device 13 includes a mobile communication module, a satellite positioning module and the like; communication numbers of the smart phone and the backup phone or the PC mobile terminal 2 of the vehicle owner, the alarm command center 4 and the like may be verified and paired through the mobile communication device 13 in the system; the communication numbers of the smart phone and the backup smart phone or the PC mobile terminal 2 of the vehicle owner, the alarm command center 4 and the like may be shared and interacted with information of the multi-purpose vehicle smart monitoring system 1 only after being preset; the vehicle owner can visually monitor real-time information such as AVs of situations inside, outside and around the vehicle through the smart phone or the backup smart phone and the PC mobile terminal 2 (fully authorized and set by the vehicle owner) of the vehicle owner at any time via the multi-purpose vehicle smart monitoring system 1, and can inquire the geographical position where the multi-purpose vehicle smart monitoring system 1 is positioned, displacements such as movement change data and other relevant vehicle information at any time; the smart phone of the vehicle owner may be used for setting all work instructions and permission settings for operating the multi-purpose vehicle smart monitoring system 1, or carrying out relevant smart operations on the vehicle using the multi-purpose vehicle smart monitoring system 1.

According to the multi-purpose vehicle smart monitoring system, the wireless interconnection device 14 includes a wireless network (WiFi or Bluetooth etc.) communication module which is wirelessly interconnected with the smart phone or the PC mobile terminal 2, and by adoption of direct connection, their connection may be automatically implemented if they are successfully paired once, so that no wireless router is needed, and no network flow fees are caused; and connection with corresponding operations such as automatic recognition, starting, displaying, synchronization, downloading, control, changeover, shutting off, power-saving switching and the like of the multi-purpose vehicle smart monitoring system 1 may be realized at any time.

According to the multi-purpose vehicle smart monitoring system, the memory 15 includes an expandable high-capacity memory and a memory card interface, and may expandably and automatically store monitoring and monitoring screenshots, geographical position and latitude and longitude movement data, text pictures, audios and videos and other types of information; if external force actions such as tapping and breakage of the vehicle window, opening of the vehicle door, prying of the trunk, slight scratching and rubbing collision are sensed by the smart sensing device 11 or the smart sensing device 11 senses that there is a thief intruding into the vehicle, the memory will automatically store and lock a period of AV record before and after these events; when the vehicle stops and is switched off or during vehicle running, this memory would automatically lock and store a period of AV record before and after an event as long as the sensor of this system senses sudden valuable key information, and then automatically lock information such as key audios and videos and pictures into a memory card to prevent the information from being covered by loop videos, so that key evidences are retained, and no seconds leak.

According to the multi-purpose vehicle smart monitoring system, the EOS embedded system 10 includes an embedded computer, an electro-acoustic conversion element (including a microphone, a loudspeaker and the like) and a short-distance wireless communication (Bluetooth) module; after the module is successfully paired with and recognizing wireless Bluetooth of the smart phone of the vehicle owner, the vehicle owner may carry out corresponding smart operations such as automatic recognition, starting, shutting off, control, changeover, power-saving switching and the like with the multi-purpose vehicle smart monitoring system 1 at any time during daily use.

According to the multi-purpose vehicle smart monitoring system, the rechargeable battery 16 includes a battery (most preferably, a lithium ion battery) with the capacity at least larger than 5,000 mA·h, a charging overload protection circuit, a multi-purpose external expansion charging port, a vehicle charging adapter and other assorted lines; the rechargeable battery 16 of the multi-purpose vehicle smart monitoring system 1 may be recharged through an automotive alternator after the vehicle is started or during vehicle running, and also may be connected with an external solar charging panel for charging; the rechargeable battery 16 provides independent electric energy to the whole multi-purpose vehicle smart monitoring system including the smart sensing device 11, the automatic monitoring equipment 12, the mobile communication device 13, the wireless interconnection device 14, the memory 15 and the EOS embedded system 10 and the like; and the multi-purpose vehicle smart monitoring system may at least work continuously in a standby manner for months after being fully charged.

According to the multi-purpose vehicle smart monitoring system, the multifunctional button 3 includes a low-power-consumption wireless Bluetooth (serial port unvarnished transmission) module, a battery and the like; after being successfully paired with the Bluetooth in the multi-purpose vehicle smart monitoring system 1, the multifunctional button 3 is pressed to wirelessly operate and connect the multi-purpose vehicle smart monitoring system 1; when receiving a wireless instruction from the multifunctional button 3, the system will automatically dial an emergency assistance number preset in advance by the vehicle owner and call the alarm command center 4 for SOS emergency application such as emergency assistance and robbery alarming; and in addition, it will transmit detailed images such as current monitored scenes inside and outside the vehicle, a personnel movement trend and a facial expression and information such as the screenshots, the pictures, the AVs and the latitude and longitude of the geographical position to the smart phone or the PC terminal 2 with the emergency assistance number and the alarm command center 4 in time; the multifunctional button 3 also may take pictures and synchronously record short videos before and after the picture taking, and has various other uses for take candid photographs and records at any time.

The present application has the advantages that after a vehicle is switched off to turn off a power supplement, the multi-purpose vehicle smart monitoring system with a built-in independent high-capacity rechargeable battery 16 works by only using its power supply in a standby manner under a power-saving sleep mode; in a power-saving standby state with extremely low current, the working consumption of the battery is reduced to the maximum extent; only when the smart sensing device 11 senses an abnormal situation, the automatic monitoring equipment 12 is awakened, so that the system also may monitor environments inside, outside and around the vehicle in multiple visual angles and realize 360-degree panoramic monitoring in the front, back, left and right directions to transmit timely recorded information such as abnormal audios and videos inside, outside and around the vehicle to the smart phone or the PC mobile terminal 2 of the vehicle owner through the multi-purpose vehicle smart monitoring system 1, and the information also may be transmitted to a 110 platform of the alarm command center 4 through wireless connection, so that the vehicle owner can learn about real-time conditions of the vehicle and audio and video information inside and outside the vehicle at any time; the vehicle owner may operate the multi-purpose vehicle smart monitoring system through an interface of his/her smart phone and learn about real-time situations and audio and video information inside, outside and around the vehicle, so that a series of human-vehicle interaction smart operations such as reminding, checking, SOS, watching, communication, picture taking, storage, acquisition, positioning, monitoring or transmission of information such as the audios and videos to a third party may be carried out at any time; according to the vehicle model condition of the vehicle used by the vehicle owner, all sensing indexes and functional settings of the multi-purpose vehicle smart monitoring system also may be set and adjusted through the smart phone of the vehicle owner, and the sensitivities, or various functional settings such as a working way, a monitoring mode, parameter setting and configuration changeover of multiple different smart sensors may be set. During vehicle running, monitoring work such as fatigue prewarning, off-tracking prevention, collision prevention prewarning, driving assistance, synchronous recording, SOS and the like may be synchronously monitored on the smart phone or the PC mobile terminal 2 and the multi-purpose vehicle smart monitoring system through wireless interconnection; at night or in bad weather, the multi-purpose vehicle smart monitoring system may be connected to the smart phone or the PC mobile terminal 2 through the WI-FI of the wireless interconnection device 14, or may be wiredly connected to a built-in image display device of the vehicle for night-vision displaying to synchronously carry out infrared imaging technology-assistant safe driving image monitoring and the like.

### BRIEF DESCRIPTION OF THE DRAWINGS

FIG. 1 is an electrical block diagram of an embodiment of a multi-purpose vehicle smart monitoring system and a method of the present application;

FIG. 2 is a flowchart of an embodiment of a multi-purpose vehicle smart monitoring system and a method of the present application;

FIG. 3 is a structural schematic diagram of an embodiment of a multi-purpose vehicle smart monitoring system and a method of the present application;

FIG. 4 is a flowchart of an embodiment of fatigue prewarning of a multi-purpose vehicle smart monitoring system of the present application;

FIG. 5 is a flowchart of an embodiment of off-tracking prevention and collision prevention of a multi-purpose vehicle smart monitoring system of the present application.

### DETAILED DESCRIPTION OF THE INVENTION

A further detailed description will be made below to the present application in combination with accompanying drawings and embodiments.

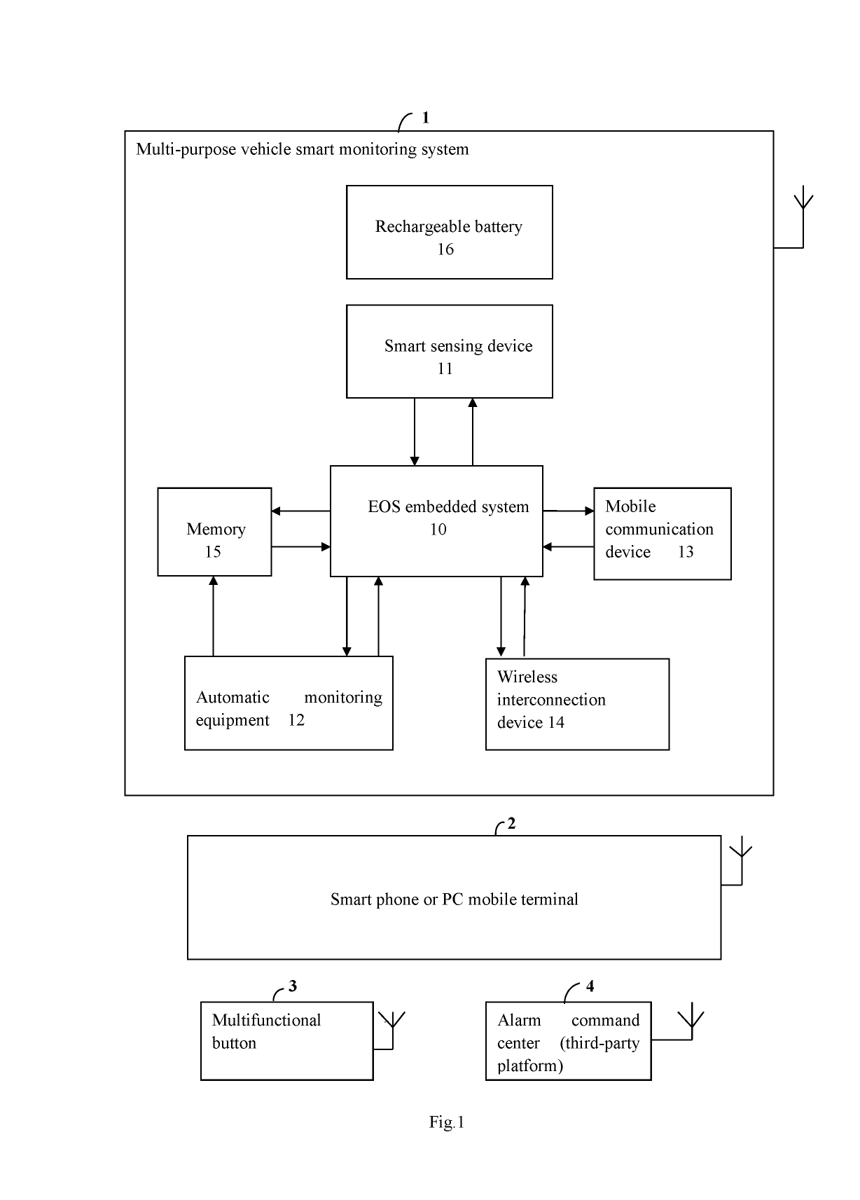

With reference to FIG. 1, the present application provides a multi-purpose vehicle smart monitoring system and a method. The multi-purpose vehicle smart monitoring system 1 includes a smart sensing device 11, automatic monitoring equipment 12, a mobile communication device 13, a wireless interconnection device 14, a memory 15, an EOS embedded system 10, a rechargeable battery 16 and the like, and may be wirelessly communicated with a smart phone or a PC mobile terminal 2 and an alarm command center 4 at any time; and a multifunctional button 3 is pressed to realize various uses of SOS emergency assistance, robbery alarming, snapshotting, recording and the like.

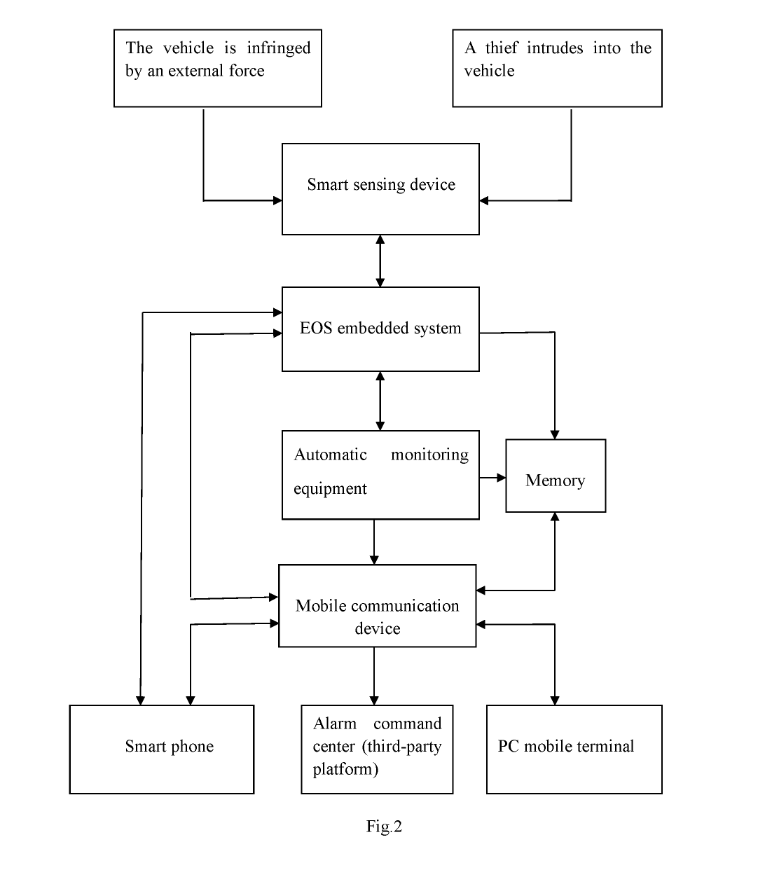

As shown in FIG. 2, when the smart sensing device 11 in the multi-purpose vehicle smart monitoring system 1 senses an abnormality, for example, when a vehicle is infringed by an external force or a thief intrudes into the vehicle, the system may comprehensively or respectively and multiply sense a sudden change of the abnormality, then awaken the EOS embedded system 10 to start the automatic monitoring equipment 12 immediately to carry out a series of work such as real-time monitoring (in addition, a period of AV record before and after the event is automatically stored and locked into the memory 15; when the vehicle is switched off or during vehicle running, this memory would automatically lock and store a period of AV record before and after the event as long as the smart sensing device 11 of this system senses sudden valuable key information, and then automatically lock information such as key audios and videos and pictures into a memory card to prevent the information from being covered by loop videos, so that key evidences are retained, and no seconds leak), and transmit the abnormal audios and videos and other information to the smart phone or PC mobile terminal 2 of the vehicle owner in time through the mobile communication module 13, and may also sound an alarm directly through wireless connection with the alarm command center 4 to fulfill a smart operation aim such as human-vehicle interaction; and during the vehicle running, the automatic monitoring equipment 12 and the EOS embedded system 10 also may assist a driver in safe driving and do other types of detection work.

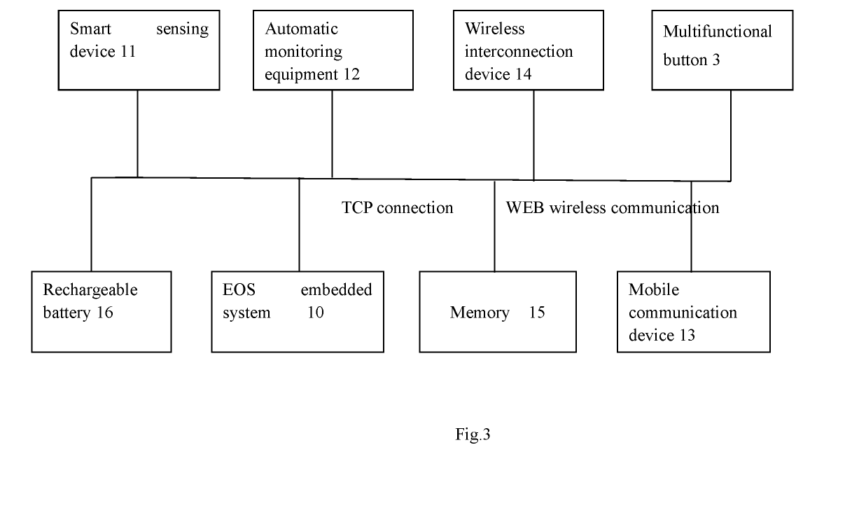

FIG. 3 shows a structure, functions and a logic relation of the present application. The present application provides a multi-purpose vehicle smart monitoring system and a method. The static state of the vehicle is called a “static” unattended state, after the vehicle is switched off and a power supplement is turned off, the system works by mainly depending on its built-in high-capacity rechargeable battery 16, and is in a power-saving standby state under a smart sleep mode at ordinary times; only when the smart sensing device 11 in the system senses abnormalities inside, outside and around the vehicle, that is, only when the vehicle is infringed by an external force or a thief intrudes into the vehicle (for example infringements under the action of the external force, such as tapping or breakage of a vehicle window, opening of a vehicle door and prying of a trunk, or slight scratching, rubbing collision and extremely high peripheral amplitude on the vehicle), the multi-purpose vehicle smart monitoring system 1 would start the automatic monitoring equipment 12 in it to record information such as AVs (Audio Videos) (in addition, a period of AV before and after the event is automatically stored and locked into the memory 15) of the instantaneous abnormalities inside, outside and around the vehicle, and transmit the real-time information such as the AV recorded via monitoring to the smart phone or the PC mobile terminal 2 of a vehicle owner through the mobile communication device 13 and a WEB communication carrier in the system, or sound an alarm directly through wireless connection with the alarm command center 4; all sensing indexes and all functional settings such as a working way, a monitoring mode, parameter setting, configuration changeover of the multi-purpose vehicle smart monitoring system 1 also may be set and adjusted through the smart phone of the vehicle owner; the vehicle running means that the vehicle works in a “dynamic” state, safe driving monitoring such as fatigue prewarning, off-tracking prevention and collision prevention prewarning may be carried out, and anti-fatigue driving may be carried out on the driver via technologies such as human face image analysis, eye feature movement recognition and driving behavior state monitoring through the automatic monitoring equipment 12 and the EOS embedded system 10 in the system; the system also may automatically detect and recognize a safe distance from the front vehicle and carry out sideline detection through the automatic monitoring equipment 12 to judge whether the vehicle deviates from a normal running track to realize synchronous monitoring of safe driving assistance; at night or in bad weather, safe driving monitoring may be assisted through infrared night vision in the automatic monitoring equipment 12; the multi-purpose vehicle smart monitoring system is wirelessly connected with the smart phone or the PC mobile terminal 2 of the vehicle owner through the wireless interconnection device 14 (or is wiredly connected to a built-in image display device of the vehicle for night vision displaying), may synchronously carry out infrared imaging technology-assistant safe driving night vision monitoring, thus realizing effects of dazzle light shielding, clear seeing in a foggy day, night vision assistance and the like in weather with bad light, such as backlighting, night, daytime, snowy days, foggy days and rainy days, to guarantee the driving safety all round; the multifunctional button 3 is pressed to realize SOS, robbery alarming and the like; when receiving a wireless instruction from the multifunctional button 3, the system will automatically dial an SOS number preset in advance by the vehicle owner or call the alarm command center 4 for alarming; in addition, detailed images such as current monitored scenes inside and outside the vehicle, a personnel movement trend and a facial expression and information such as the screenshots, the pictures, the AVs and the latitude and longitude of the geographical position may be transmitted to rescuers in time.

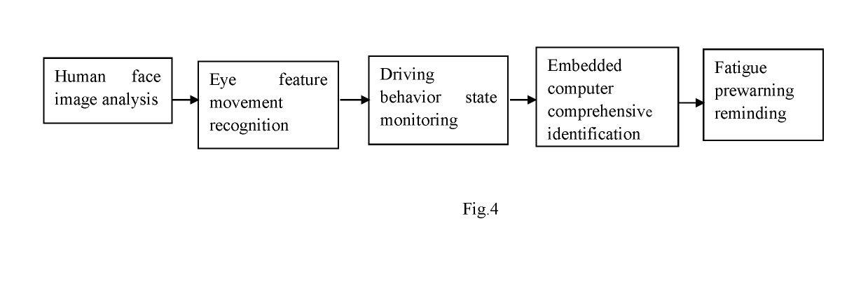

FIG. 4 shows a safety step that technologies such as human face image analysis, eye feature movement recognition and driving behavior state monitoring are carried out on a driver to prevent fatigue driving through the automatic monitoring equipment 12 and the EOS embedded system 10 in the multi-purpose vehicle smart monitoring system 1.

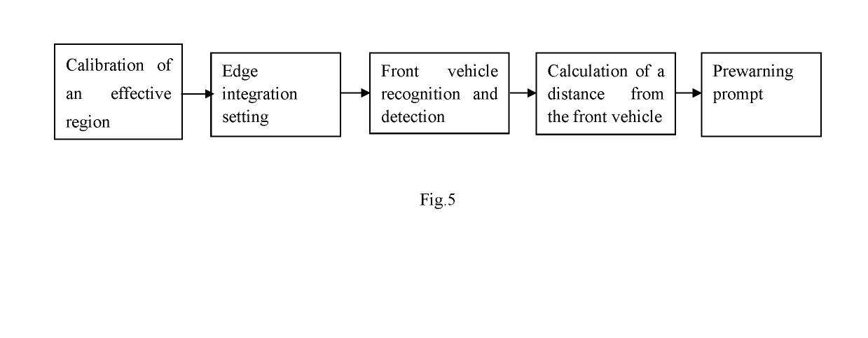

FIG. 5 shows a step of realizing synchronous monitoring of driving safety assistance by automatically detecting and recognizing a safe distance from a front vehicle and carrying out sideline detection to judge whether a vehicle deviates from a normal running track through the automatic monitoring equipment 12 and the EOS embedded system 10 in the multi-purpose vehicle smart monitoring system 1, wherein at night or in bad weather, the safe driving assistance monitoring work is synchronously carried out through an infrared imaging technology in the automatic monitoring equipment 12 (to let the driver still have a clear view in a dark area beside headlamp lighting, and if someone intrudes into a driving route, the system will capture the pedestrian with infrared rays and sound an alarm in time).

What is claimed is:

1. A multi-purpose vehicle smart monitoring system, characterized by comprising a smart sensing device, an EOS embedded system, automatic monitoring equipment, a mobile communication device, a wireless interconnection device, a memory, a multifunctional button and a rechargeable battery;
the smart sensing device is used for sensing abnormalities inside, outside and around a vehicle;
the EOS embedded system is used for setting all functions of other devices or equipment of the system;
the automatic monitoring equipment is used for recording instantaneous abnormal information inside, outside and around the vehicle;
the mobile communication device is connected with a WEB communication carrier, and information recorded by the automatic monitoring equipment is transmitted to a smart phone or a PC mobile terminal of a vehicle owner through the mobile communication device or the wireless interconnection device;
the multifunctional button is wirelessly connected with the multi-purpose vehicle smart monitoring system, and operates the multi-purpose vehicle smart monitoring system;
the rechargeable battery is used for supplying power to the multi-purpose vehicle smart monitoring system;
the system works in a power-saving standby manner under a smart sleep mode at ordinary times; when an abnormality occurs, the EOS embedded system is awakened, and the automatic monitoring equipment is started immediately to acquire site information, and wirelessly communicates the acquired site information to the smart phone or the PC mobile terminal in time through the mobile communication device, or is directly wirelessly connected to a third-party platform such as an alarm command center to realize human-vehicle interaction, thus fulfilling the aim of smart monitoring.

2. The multi-purpose vehicle smart monitoring system according to claim 1, characterized in that the smart sensing device at least comprises a high-sensitivity gyroscope sensor with an amplitude sensing function, and an air pressure sensor capable of sensing changes of air-flow differential pressure.

3. The multi-purpose vehicle smart monitoring system according to claim 1, characterized in that the EOS embedded system comprises an embedded computer, an electro-acoustic conversion element and a short-distance wireless communication module; after the EOS embedded system is successfully paired and identified with the short-distance wireless communication of the smart phone of the vehicle owner, the vehicle owner can carry out corresponding smart operations on the multi-purpose vehicle smart monitoring system at any time during daily use.

4. The multi-purpose vehicle smart monitoring system according to claim 1, characterized in that the automatic monitoring equipment comprises at least three wide-angle monitoring camera heads with night vision functions and a group of infrared night vision smart light supplementing LEDs; the automatic monitoring equipment carries out mobile monitoring by automatically switching a lens and automatically detecting a moving target, and records a moving target appearing in the monitoring lens; the automatic monitoring equipment is installed above a front windshield of the vehicle, and can panoramically monitor environments inside and outside the vehicle at 360 degrees at any light rays.

5. The multi-purpose vehicle smart monitoring system according to claim 1, characterized in that the mobile communication device comprises at least one mobile communication module and a satellite positioning module; the mobile communication device transmits real-time information recorded via monitoring, geographical position information and movement change data information to the smart phone, a backup smart phone or a PC mobile terminal of the vehicle owner, the alarm command center or the third-party platform.

6. The multi-purpose vehicle smart monitoring system according to claim 1, characterized in that the wireless interconnection device comprises a wireless network communication module; the wireless interconnection device is wirelessly interconnected with the smart phone or the PC mobile terminal; and by adoption of direct connection, the wireless interconnection may be automatically implemented after the wireless interconnection device and the smart phone or the PC mobile terminal are successfully paired once.

7. The multi-purpose vehicle smart monitoring system according to claim 1, characterized in that the rechargeable battery is a high-capacity rechargeable battery which is provided with a charging overload protection circuit and a multi-purpose external charging interface and may be directly connected to a vehicle charger; after the vehicle is started or during vehicle running, an automotive alternator charges the battery; or the battery is connected with a solar charging panel for charging; and the battery independently supplies electric energy to the multi-purpose vehicle smart monitoring system.

8. The multi-purpose vehicle smart monitoring system according to claim 1, characterized in that the memory comprises an expandable high-capacity memory and a memory card interface or a cloud disk; and the memory stores information of the abnormalities inside, outside and around the vehicle in time and automatically locks the information.

9. The multi-purpose vehicle smart monitoring system according to claim 1, characterized in that the multifunctional button comprises a low-power-consumption wireless Bluetooth module and a battery; after being successfully paired with the wireless interconnection device, the multifunctional button is pressed to wirelessly operate and connect the multi-purpose vehicle smart monitoring system.

10. A method of implementing a multi-purpose vehicle smart monitoring system, characterized by comprising:
setting the system to work in a power-saving standby manner under a smart sleep mode at ordinary times;
when a smart sensing device of the multi-purpose vehicle smart monitoring system senses abnormalities inside, outside and around the vehicle, the multi-purpose vehicle smart monitoring system starts automatic monitoring equipment to record information of the instantaneous abnormalities inside, outside and around the vehicle;
transmitting the real-time information recorded via monitoring to a smart phone and/or a backup smart phone, PC mobile terminal of a vehicle owner or a third-party platform through a mobile communication device in the system, so that the vehicle owner can learn about the instantaneous information of the vehicle and situations inside, outside and around the vehicle in time at any time anywhere;
enabling the vehicle owner to directly operate the multi-purpose vehicle smart monitoring system through the smart phone, learn about monitored information of the real-time situations inside, outside and around the vehicle at any time to realize a series of smart operations such as human-vehicle interaction, and monitor the monitored information of the real-time situations inside, outside and around the vehicle all the time; and
enabling the vehicle owner to set and adjust all functional index settings through the smart phone according to a model condition of the vehicle used.
